(19) United States
(12) Patent Application Publication
(10) Pub. No.: US 2020/0285559 A1
(43) Pub. Date: Sep. 10, 2020

(54) SYSTEM, APPARATUS AND METHOD FOR DYNAMIC TRACING IN A SYSTEM HAVING ONE OR MORE VIRTUALIZATION ENVIRONMENTS

(71) Applicant: Intel Corporation, Santa Clara, CA (US)

(72) Inventors: ROLF KUEHNIS, Portland, OR (US); PETER LACHNER, Heroldstatt (DE)

(21) Appl. No.: 16/878,976

(22) Filed: May 20, 2020

(51) Int. Cl. G06F 11/36; G06F 9/455

(52) U.S. Cl. CPC G06F 11/364; G06F 2009/45591; G06F 9/45558

(57) ABSTRACT

In one embodiment, an apparatus includes: a first hardware circuit to execute operations and a trace hardware circuit coupled to the first hardware circuit. At least one virtualization environment to be instantiated by a virtualization environment controller is to execute on the first hardware circuit. The virtualization environment controller may receive from a first virtualization environment a first trace message and a first platform description identifier to identify the first virtualization environment, remap the first platform description identifier to a second platform description identifier and send the first trace message and the second platform description identifier to the trace hardware circuit. In turn, the trace hardware circuit may send the first trace message and the second platform description identifier to a debug and test system. Other embodiments are described and claimed.

### TECHNICAL FIELD

Embodiments relate to tracing techniques for semiconductors and computing platforms.

### BACKGROUND

Trace is a debug technology used widely in the semiconductor and computing industry to address, e.g., concurrency, race conditions and real-time challenges. Modern processors such as system on chips (SoCs) often include several hardware trace sources, and users are adding their software (SW)/firmware (FW) traces to the same debug infrastructure. For systems that aggregate several different trace sources into a combined trace data stream, a receiving tool has to have a priori knowledge of the system that generated a particular trace stream to understand the different trace sources. For example, a system ID is used to describe a system and different IDs/addresses from the trace sources can be used to unwrap the merged trace stream into different logical trace streams and identify each trace stream's trace source and its underlying trace protocol for decode.

A static assignment of trace sources and a static assignment of trace protocols to those sources are typically used. However, some systems do not have a static system topology, and thus cannot effectively leverage available tracing systems. This is especially so in systems providing virtualization environments, where these environments can be dynamically created and destroyed during runtime. Still further, such virtualization environments have properties that make it difficult for trace activities to occur. Un-decodable traces due to missing information of the origin (platform) of the traces may reduce or even completely eliminate debugging capabilities, which increases the effort to identify and triage issues on customer platforms and can have a negative impact on product releases

### BRIEF DESCRIPTION OF THE DRAWINGS

FIG. 1 is a block diagram of a portion of a processor in accordance with an embodiment.

FIG. 2 is a block diagram of a system in accordance with an embodiment of the present invention.

FIG. 3 is a flow diagram of a method in accordance with an embodiment of the present invention.

FIG. 4 is a flow diagram of a method in accordance with another embodiment of the present invention.

FIG. 5 is a flow diagram of a method in accordance with yet another embodiment of the present invention.

FIG. 6 is a flow diagram of a method in accordance with a still further embodiment of the present invention.

FIG. 7 is a diagram illustrating representative trace sources and resulting trace messages and trace streams in accordance with an embodiment.

FIG. 8 is an illustration of a decoding process in accordance with an embodiment.

FIG. 9A is a data format of a PDID message in accordance with an embodiment of the present invention.

FIG. 9B is a data format of a PDID timestamp message in accordance with an embodiment of the present invention.

FIG. 10 is a data format of example PDID messages in accordance with an embodiment of the present invention.

FIG. 11 is a block diagram of a decoder structure in accordance with an embodiment.

FIG. 12 is a block diagram of a system in accordance with another embodiment of the present invention.

FIG. 13 is a flow diagram of a method in accordance with another embodiment of the present invention.

FIG. 14 is a flow diagram of a method in accordance with yet another embodiment of the present invention.

FIG. 15 is a format for a PDID packet in accordance with an embodiment of the present invention.

FIG. 16 is a block diagram of a system in accordance with another embodiment of the present invention.

FIG. 17 is a block diagram of a system in accordance with another embodiment.

FIG. 18 is an embodiment of a fabric composed of point-to-point links that interconnect a set of components.

FIG. 19 is an embodiment of a system-on-chip design in accordance with an embodiment.

FIG. 20 is a block diagram of a system in accordance with an embodiment of the present invention.

### DETAILED DESCRIPTION

In various embodiments, a debug system is provided with techniques to provide a platform description composed out of an accumulation of descriptions (subsystem descriptions). This platform description identifier is used to describe arbitrary complex systems via support for indefinite deep nesting of subsystems and an arbitrary amount of subsystem descriptions. By way of the temporal nature of each description item, systems can be dynamically changed while maintaining debug capabilities. Such changes may include physical changes (e.g., plug/unplug components), changes due to power options (powering up or down of components), dynamically loading/unloading software/firmware modules and code paging in microcontrollers, among others.

With embodiments, a processor or other SoC can provide a more reliable and higher quality output to trace analysis tools. Embodiments reduce the risk of totally unusable data, by providing the ability to properly decode traces. And with embodiments, message content is reduced via the techniques described herein to reduce code density, especially as compared to use of a globally unique identifier (GUID) on every message. As such, embodiments realize higher code density and lower trace bandwidth requirements.

As used herein, a “trace” is a stream of data about system functionality and behavior of a target system, transported to a host system for analysis and display. In other cases, the trace can be self-hosted, in which the data is consumed in the system itself by a debug engine that decodes and potentially visualizes the data. A “trace source” is an entity inside the system that generates trace information using a defined protocol. A “platform description ID” (PDID) describes a (sub)system or part of it. A (sub)system could be a single trace source or another complex nested (sub)system. In turn, platform description metadata information translates the PDID into data to configure a debug component processing the given trace stream. And in turn, a platform description is the accumulation of all platform description metadata of the received platform description IDs at a particular point in time. As used herein, a “decoder system” is a collection of software components to decode a single trace source entity (also called a subsystem herein). A “decoder book” is the collection of different “decoder systems” (also known as subsystem decoders) to decode traces from a system described by a single ID code.

In different embodiments, the destination of tracing information may be a remote entity to receive the tracing information via a streaming interface or a local storage, e.g., in a ring buffer, main memory of a file system. In embodiments, there are two flavors of the platform description ID (PDIDs), which together enable a unique trace source identification. A global PDID is used to define the name space of the trace decoding, and is a root for the decoder. In turn, local PDIDs are part of the name space. These local PDIDs are unique in the name space created by the global PDID.

In operation, a PDID is periodically injected into the trace stream, which in one embodiment is a SoC-wide Joint Test Action Group (JTAG) ID code, to ground the decoding to a specific product. While a JTAG code is one implementation, other unique identifiers can be used such as a System GUID or any other vender-defined unique number. This can be done in case of a MIPI system trace protocol (STP) wrapper protocol via periodic synchronization messages such as an STP ASYNC message. Other synchronization point injections are possible, such as at the start or end of an ARM or MIPI Trace Wrapper Protocol (TWP) frame boundary. This enables a clear identification of a trace log to a hardware product. In case of a ring buffer, ASYNC messages ensure that at least 1 (or 2) ASYNC packets are available. Having an ASYNC message in the ring buffer ensures decoding, e.g., according to a given sampling theorem. For example, ASYNC messages may be injected at half of the ring buffer size (such as according to a Nyquist-Shannon sampling theorem). With the PDID extension, the root is in the trace storage.

During the tracing, one or several specific platform description identifier(s) per subsystem may be sent. These identifiers can be issued from a firmware engine, a hardware block or a software process or application. The messages may be timestamped to provide information when some subsystems become available or become invisible (dormant, removed, etc.).

As one example an application can send its PDID(App) at its start, while a more static firmware engine periodically can send its PDID(FW). Note that PDID data can also be stored in parallel (out-of-band) for offline read when needed. As an example, the data may be stored on a target system's file system together with the traces for later consumption.

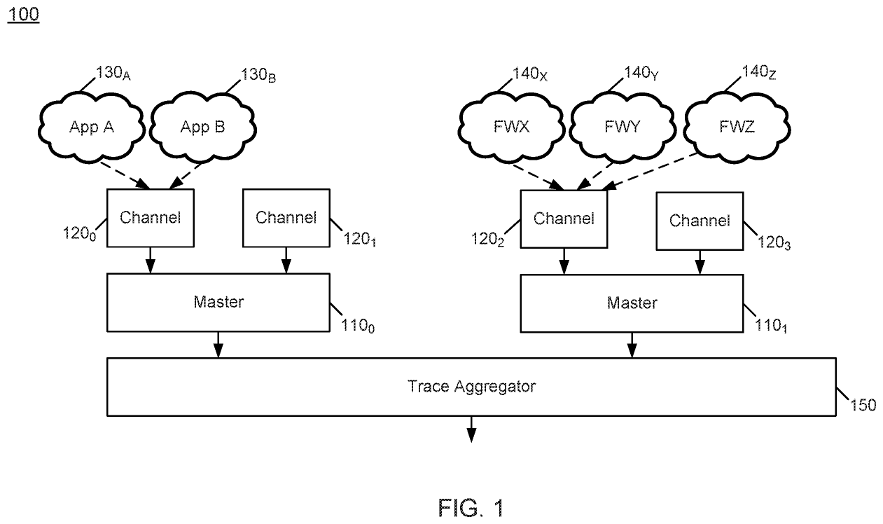

Referring now to FIG. 1, shown is a block diagram of a portion of a processor in accordance with an embodiment. As shown in FIG. 1, processor 100 may be a multicore processor or other type of system on chip (SoC). In the illustration of FIG. 1, processor 100 is shown with a logical view with regard to debug aspects of the processor. More specifically, several masters 110₀, 110₁ are shown. As examples, masters 110 may be representative collection points for various hardware circuitry, such as a given die, high level domain or so forth. In turn, multiple channels 120 may be present in association with corresponding masters 110. In embodiments, channels 120 may be processing circuits such as processing cores, graphics processors, interface circuitry or any other type of circuitry. More specifically, channels 120₀, 120₁ are associated with master 110₀, while channels 120₂, 120₃ are associated with master 110₁. As another example, some of the trace sources may be embedded controllers, chiplets, Peripheral Component Interconnect Express (PCIe) compute components, field programmable gate array (FPGA) and graphics processing unit (GPU) extension cards, companion dies and so forth.

As further illustrated, representative channels 120₀, 120₂ may have their configurations dynamically updated during operation, e.g., based on execution of particular code. For example, different applications 130_{A,B} may execute on channel 120₀. As will be described herein, a dynamic identifier may be associated with channel 120₀ depending upon which application 130 is in execution. In this way, trace messages generated within channel 120₀ during application execution may be appropriately decoded based at least in part on using a local platform description identifier associated with a particular decoder (that in turn is associated with the corresponding application in execution). Similarly, channel 120₂ may be dynamically re-configured to execute different firmwares, e.g., firmwares 140_{X-Z}. In similar manner, a dynamic identifier may be associated with channel 120₂ depending upon which firmware 140 is in execution.

Note that, especially with regard to applications 130 and firmware 140, it is possible for third party vendors to provide such components, and thus a processor manufacturer has less visibility (a priori) information as to their arrangement and use.

As further shown in FIG. 1, masters 110 are in communication with a trace aggregator 150, which may be implemented as a given hardware circuit such as dedicated debug circuitry, general purpose processing circuitry or so forth, and in some cases may be implemented at least in part in firmware, software and/or combinations thereof. In embodiments, trace aggregator 150 may generate a merged trace stream, which it may communicate to a given destination, e.g., an on-chip storage or a chip-external location, such as an external debug and test system (DTS). In any event, trace aggregator 150 may generate a global platform description identifier for communication within the trace stream, and may receive incoming local platform description identifiers and trace messages from given masters 110, and interleave the received information into the trace stream for communication to the destination. Understand while shown at this high level in the embodiment of FIG. 1, many variations and alternatives are possible. For example, while FIG. 1 shows a high level logical view, understand that a given processor may be implemented as one or more semiconductor die implemented within an integrated circuit.

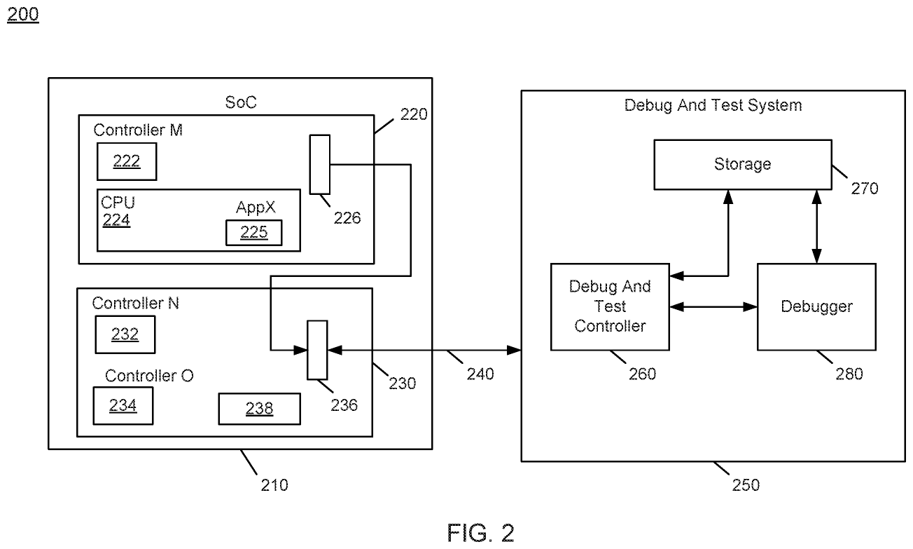

Referring now to FIG. 2, shown is a block diagram of a system in accordance with an embodiment of the present invention. As shown in FIG. 2, a debug scenario occurs in an environment 200 in which an SoC 210 couples to a debug and test system (DTS) 250. As shown in FIG. 2, SoC 210 may be implemented as a multi-die package, including a first die 220 and a second die 230. In the embodiment shown, first die 220 includes a given controller 222 and a central processing unit (CPU) 224 on which an application 225 executes. While only these limited components are shown in FIG. 2, understand that a given die may include many additional components.

As further represented with regard to trace information, trace messages and associated platform description identifiers as described herein generated in CPU 224 and controller 222 may couple through a first level trace aggregator 226 for communication to a second level trace aggregator 236 of second die 230.

As illustrated, second die 230 further includes controllers 232, 234. In addition to interleaving trace messages and local platform description identifiers from controllers 232, 234, trace aggregator 236 further interleaves message information received from trace aggregator 226. With the arrangement in FIG. 2, merged trace messages from controller 222 and CPU 224 as aggregated in trace aggregator 226 may be sent into an input port of trace aggregator 236, where such messages may be further aggregated with the trace messages received from controllers 232, 234. As further illustrated in FIG. 2, SoC 210 also may include a memory 238 such as a given non-transitory storage medium in which trace information may be stored. Although in the embodiment of FIG. 2 memory 238 is shown as present on second die 230, understand that in other cases, it may be located on first die 220 or on another die of SoC 210.

Further in the embodiment of FIG. 2, SoC 210 couples to DTS 250 via a link 240. In different embodiments, link 240 may be implemented with a connector to communicate trace and control information, e.g., according to a parallel trace information (PTI) format or a format for another link such a universal serial bus or Ethernet link. In the high level shown in FIG. 2, DTS 250 includes a debug and test controller 260, which may initiate test operations within SoC 210 and receive a trace stream therefrom. In turn, debug and test controller 260 may provide trace messages to debugger 280, which may decode the information stored therein using one or more decoders present in one or more decoder books. In an embodiment, a decoder storage may take the form of a hierarchical decoder structure to be accessed using a combination of a global platform description identifier and local platform description identifiers. As further illustrated in FIG. 2, DTS 250 also includes a storage 270, which may be implemented as a non-transitory storage medium. In some cases, storage 270 may store a decoder, such as a hierarchical decoder structure as described herein. In other cases, such decoder may be present within debugger 280 itself.

With an arbitrarily nested system as in FIG. 2, the following PDIDs in Table 1 may be used to identify the system components. In Table 1, various components within SoC 210 may be associated with given master identifiers and channel identifiers, and similarly may communicate PDIDs that have a payload corresponding to a given identifier such as a custom identifier, GUID or other such value.

TABLE 1

| | |
|---|---|
| ASYNC | VERSION PDID_TS (global) IDcode SocA TS(n) |
| M#/C#-Controller 232 | PDID_TS (sub-system) CUSTOM-ID (Controller 232) TS (n + 1) |
| M#/C#-Controller 234 | PDID_TS (sub-system) GUID (Controller 234) TS (n + 2) |
| M#/C#-N-2-S | <nested STP from Die-220 Trace Aggregator as D64s> |
| M#/C#-Controller 222 | PDID_TS (sub-system) CUSTOM-ID (Controller 222) TS (n + 3) |
| M#/C#dyn SW apps | PDID_TS (sub-system) GUID (AppX) TS (n + 100) |

When tracing in environment 200, each die 220, 230 may periodically send its unique identifier (e.g., a JTAG ID code) into the single trace stream, each defining an independent name space. This identifier grounds the decoding. In some cases it is possible for each die to be assigned a master ID and corresponding channel IDs for software that runs on such masters. In other cases, depending on die structure (e.g., whether there is a trace link between the dies or a full interconnect), hardware sources of the other die may be viewed as masters, or a complete die may be added into one single master of a main trace merging unit.

In an embodiment, a firmware engine typically has a fixed code and therefore fixed trace sources. Such trace sources may send periodically a fixed PDID. Such fixed PDIDs (also referred to herein as static PDIDs) may be used to enable a decoder to debug trace messages following this PDID within the trace stream in a first step of decoding. And with a fixed PDID, more traces can be made visible in a second step of decoding (namely those trace messages recieved pre-PDID). In contrast, other firmware engines may perform paging, where the performed task is changed dynamcially for such engines. The PDID is flexible, and only traces after the PDID is received become visible, and thus trace messages following this dynamic PDID may be decoded in a single step of decoding. As another example, plug-in cards, sending traces via second die 230, may inject another global PDID and further fixed or flexible PDIDs. In an embodiment, a discrete GPU likely has a fixed PDID, while an artificial intelligence (AI) accelerate card provides mainly flexible PDIDs.

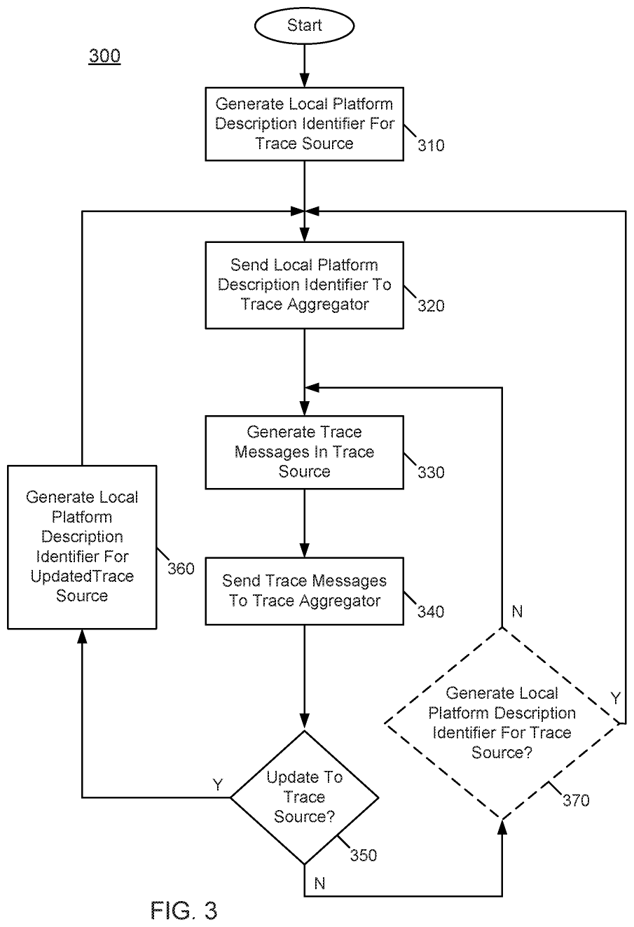

Referring now to FIG. 3, shown is a flow diagram of a method in accordance with an embodiment of the present invention. More specifically, method 300 shown in FIG. 3 is a method for providing trace information from a trace source in accordance with an embodiment. As such, method 300 may be performed by hardware circuitry, firmware, software and/or combinations thereof such as may be implemented in a given trace source, e.g., a processor core or other hardware circuit.

As illustrated, method 300 begins at block 310 by generating a local platform description identifier for the trace source. This identifier may include various information fields, including an indication as to whether the local PDID is a static identifier or a dynamic identifier. The decision to enable a given trace source for static or dynamic identification may be based on whether the trace source can be dynamically updated, e.g., with programming such as execution of a given application, or installation of a particular firmware. In any event, control next passes to block 320 where the local PDID is sent to a trace aggregator, e.g., an on-chip circuit. Thereafter at block 330 trace messages may be generated in the trace source. The trace messages may provide information regarding particular execution instances within the trace source. Thereafter, at block 340 the trace messages can be sent to the trace aggregator.

Still with reference to FIG. 3, understand that a given trace source may periodically update its configuration, e.g., by installation of a new application, firmware or in another manner. In such case it is determined at diamond 350 that an update has occurred to the trace source. In this instance, control passes to block 360 where an updated local PDID may be generated for this updated trace source. Control next passes to block 320 discussed above. Instead if it is determined that there is no update to the trace source, it may periodically be determined, optionally (at diamond 370) whether it is appropriate to send another instance of the local PDID (which in this case does not change in this static situation). If it is determined that it is appropriate to generate and send the local PDID again, control thereafter passes to block 320, discussed above. Otherwise control passes back to block 330. Understand while shown at this high level in the embodiment of FIG. 3, many variations and alternatives are possible.

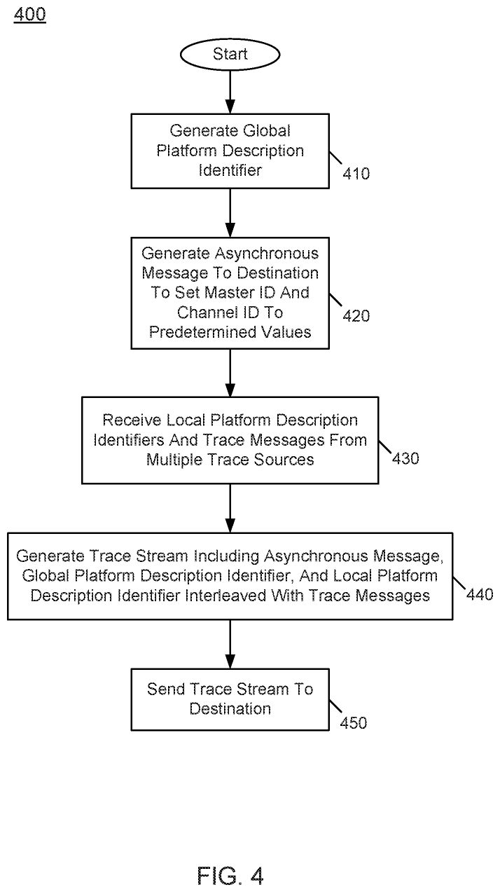

Referring now to FIG. 4, shown is a flow diagram of a method in accordance with another embodiment of the present invention. More specifically, method 400 shown in FIG. 4 is a method for aggregating trace information in a trace aggregator in accordance with an embodiment. As such, method 400 may be performed by hardware circuitry, firmware, software and/or combinations thereof such as may be implemented in a given trace aggregator, which may be implemented as a trace merging unit of a MIPI Trace Wrapper Protocol (TWP) or a MIPI System Trace Protocol (STP), or any other fabric to act as a merging function.

As illustrated, method 400 begins by generating a global platform description identifier (block 410). As an example, the trace aggregator may generate this global PDID when it is to begin performing debug operations. Next at block 420 an asynchronous message may be prepared as part of a synchronization sequence, which is sent to the destination to set a master identifier and a channel identifier to predetermined values (block 420). As an example, this asynchronous message may set master and channel IDs both to zero. Understand of course that other values are possible, and it is further possible that different ID values for master and channel can be set by way of an asynchronous message. At this point, the trace aggregator is ready to send a trace stream including aggregated trace messages.

Control next passes to block 430 where local PDIDs and trace messages may be received from multiple trace sources. Next at block 440 the trace aggregator may generate a trace stream that includes various information, including the asynchronous message, the global PDID and local PDIDs, which may be interleaved with the trace messages themselves. Thereafter at block 450 this trace stream is sent to the destination, which may be a destination storage or an external debug and test system. Understand while shown at this high level in the embodiment of FIG. 4, many variations and alternatives are possible.

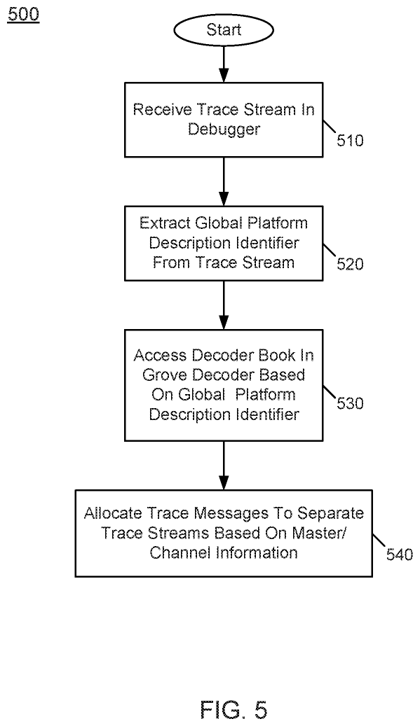

Referring now to FIG. 5, shown is a flow diagram of a method in accordance with yet another embodiment of the present invention. More specifically, method 500 shown in FIG. 5 is a method for handling an incoming trace stream in a debugger in accordance with an embodiment. As such, method 500 may be performed by hardware circuitry, firmware, software and/or combinations thereof such as may be implemented in a given debug and test system.

Method 500 begins by receiving a trace stream in a debugger (block 510). Next at block 520, a global PDID may be extracted from this trace stream. Using this extracted global PDID, the debugger may access a decoder book (of multiple such decoder books) in a grove decoder (block 530). As such, the global PDID acts as a root to identify a particular decoder book within the decoder structure. Next the debugger may allocate trace messages to different trace streams based on master/channel information (block 540). That is, as an incoming trace stream may include interleaved trace messages and PDIDs from various trace sources, to properly decode this information, the trace messages and corresponding PDIDs may be separated into different streams and may be, e.g., temporarily stored in a given buffer storage. To enable this parsing of incoming trace messages, master/channel information included in the trace messages may be used to allocate individual trace messages to the appropriate trace stream. Understand while shown at this high level in the embodiment of FIG. 5, many variations and alternatives are possible.

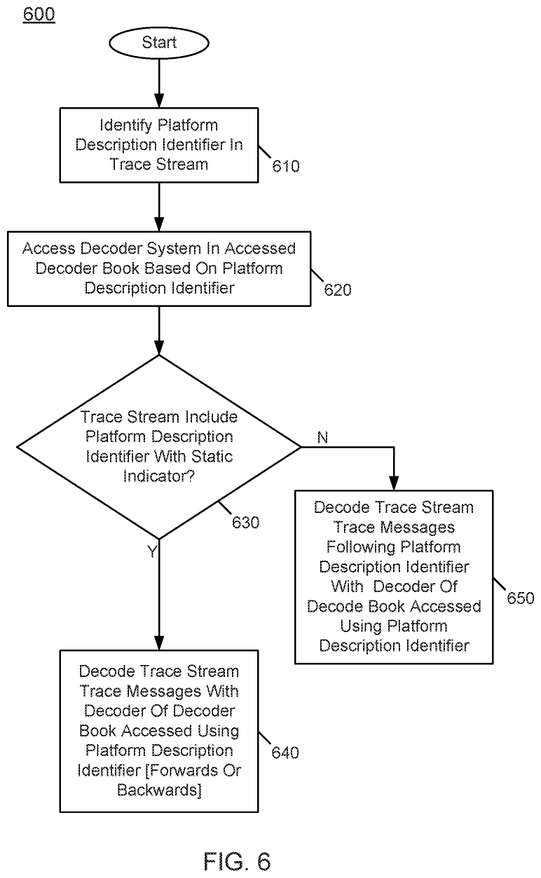

Referring now to FIG. 6, shown is a flow diagram of a method in accordance with a still further embodiment of the present invention. More specifically, method 600 shown in FIG. 6 is a method for performing decoding of trace information in accordance with an embodiment. As such, method 600 may be performed by hardware circuitry, firmware, software and/or combinations thereof such as may be implemented in a given debug and test system.

As illustrated, method 600 begins by identifying a PDID within a trace stream (block 610). Using this PDID, a given decoder system within the decoder book (in turn accessed using a global PDID) is accessed (block 620). Still with reference to FIG. 6, control passes from block 620 to diamond 630 where it is determined whether the PDID includes a static indicator. If so, control passes to block 640 where trace messages within this trace stream may be decoded with the decoder using the accessed decoder system, both in a forwards and backwards manner. That is, trace messages may be decoded regardless of whether the trace messages were received before or after receipt of the local PDID. As such, decoding may be performed according to a two-step process in which for a first step, trace messages following the static PDID can be decoded. Then in a second step, trace messages preceding the static PDID within the trace stream also can be decoded.

In contrast, in situations where a PDID is a dynamic identifier, only messages received after receipt of the local PDID may be properly decoded using a given decoder subsystem. Thus when it is determined at diamond 630 that the PDID is not associated with a static indicator (and thus is associated with a dynamic indicator), control passes to block 650, where trace messages following the PDID within this trace stream may be decoded with the decoder using the accessed decoder system. Note in this case with a static PDID, only trace messages following the PDID in the trace stream can be decoded. Understand while shown at this high level in the embodiment of FIG. 6, many variations and alternatives are possible.

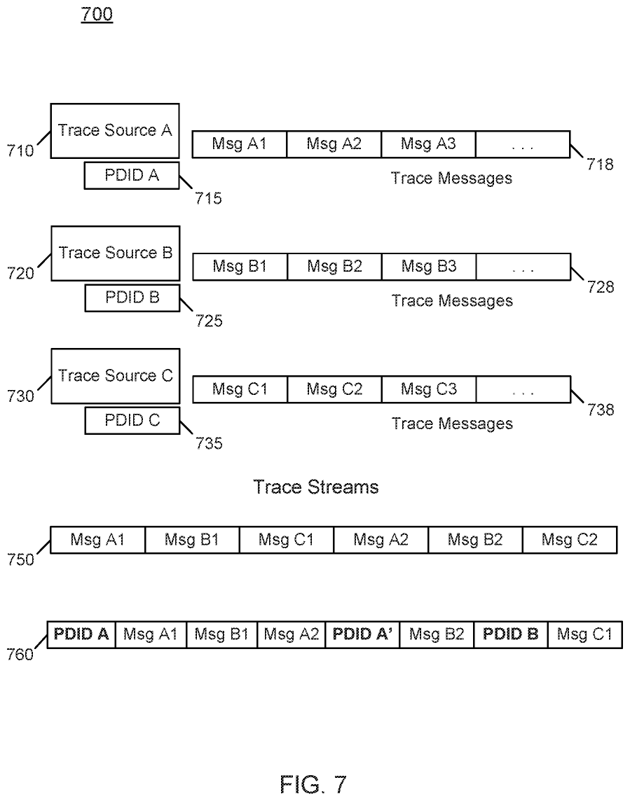

Referring now to FIG. 7, shown is a diagram illustrating representative trace sources and resulting trace messages and trace streams in accordance with an embodiment. As shown in FIG. 7, in an environment 700, multiple trace sources 710, 720, 730 may be present. Such trace sources may be representative hardware circuits, firmware engines, or so forth. In any event, each trace source is associated with a corresponding (local) PDID 715, 725, 735. During debug operations, each trace source may generate a stream of trace messages, respectively, trace message streams 718, 728, 738.

Such trace messages, along with the corresponding PDID is sent from a given trace source to a trace aggregator (not shown for ease of illustration in FIG. 7). The trace aggregator may be configured to interleave incoming trace messages to generate trace streams. Two representative trace streams 750 and 760 are shown in FIG. 7. Trace stream 750 may be a portion of a given trace stream in which interleaved trace messages from the above three trace sources are included. Note however that in this subset of a trace stream, only trace messages are included, and not any PDIDs. Of course note that each such trace message may include appropriate identification information, e.g., in the form of master/channel information, to act as an alias for a larger address.

In turn, trace stream 760 shows an instance in which these PDIDs are included with interleaved trace messages in a trace stream. Note further that with regard to representative trace source 710, a dynamic PDID (PDID A′) is further sent, illustrating a dynamic update to a local PDID, e.g., as a result of a change to trace source 710 (such as execution of a new application, paging in of a different firmware or so forth). With merged trace streams 750, 760, a resulting single trace stream is output for exporting via a given streaming interface (e.g., universal serial bus (USB), Peripheral Component Interconnect Express (PCIe), wireless local area network (WLAN)) or for local storage (e.g., dynamic random access memory (DRAM), static random access memory (SRAM), solid state drive (SSD)). As illustrated the PDID may be sent at the beginning of a trace stream (e.g., PDID A for an application start in FIG. 7) or during the stream (e.g., periodic firmware PDID B). It is also possible that a trace source sends an updated PDID (e.g., dynamically loading of additional libraries and PDID A′ in FIG. 7) after dynamic changes in the trace source.

In an embodiment, a PDID message is composed of 0 . . . n PDID data packets, terminated via a PDID_TS packet. TS is a time-stamp, allowing the time correlation of dynamic PDIDs. Both PDID and PDID_TS packets can be configured to be master/channel bound. A PDID message is framed by the timestamp (as an end of message marker). Several PDID/PDID_TS packets construct a complete message. The size is flexible.

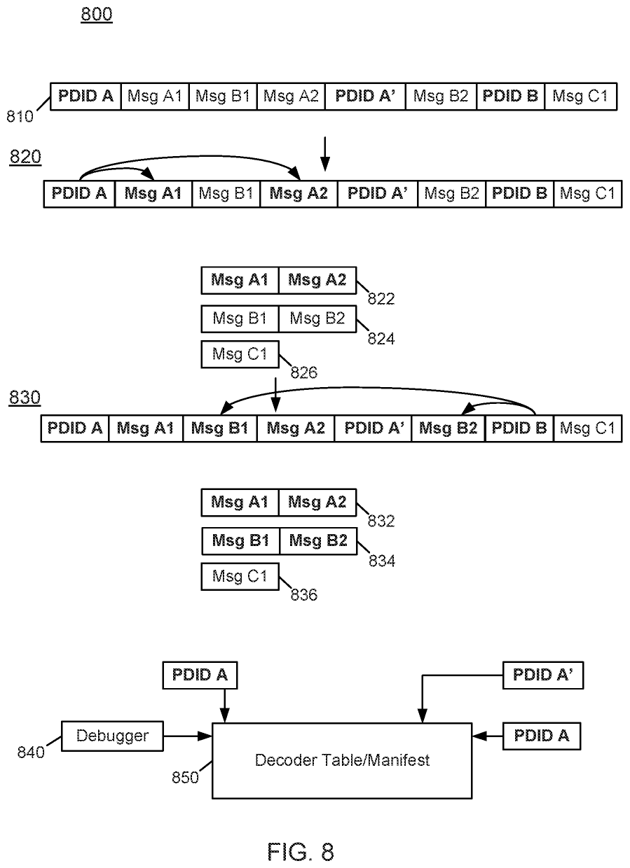

Referring now to FIG. 8, shown is an illustration of a decoding process 800 in accordance with an embodiment. Decoding process 800 may be executed by a debugger as present in a given debug and test system, which may be implemented with hardware circuitry, firmware, software and/or combinations thereof. In embodiments herein, a debugger 840 couples to a decoder table 850/manifest, which may be a hierarchical decoder structure as described herein.

As illustrated in FIG. 8, a trace stream 810 is received that includes various trace messages, with PDIDs interleaved within the trace stream. In a first decoding step (illustrated at 820), messages for a first trace source associated with a first local PDID (PDID A) may be decoded in a forward direction as these trace messages (messages A1, A2) follow after the PDID. This forward-based decoding may thus occur for a variety of trace sources, including those associated with flexible or dynamic PDIDs (namely those which may change over time). Thus as illustrated in decoding process 820, bolded messages 822 associated with this first trace source may be decoded. As further illustrated in this decoding step, messages associated with other trace sources (namely sources B and C) may be parsed into separate trace sources 824 and 826. Yet these messages may not yet be decoded (as illustrated with bold in FIG. 8) as there has been no receipt of corresponding PDIDs for these trace sources received prior to these trace messages.

However at a second step of a decoding process (illustrated at 830), backwards decoding of trace messages associated with trace source B may occur (as shown in bold in trace stream 834) as a local PDID (PDID B) is received, and is a fixed PDID, such that backwards based decoding may be performed. However note that at this stage, as no PDID has been received for trace source C, a message 836 remains undecoded.

To enable the decoding as described herein, the PDIDs may act as pointers or addresses to access corresponding decoder subsystems within decoder table 850 to obtain the appropriate decoding information to enable decoding of the given trace streams in debugger 840. Although shown at this high level in the embodiment of FIG. 8, many variations and alternatives are possible. Thus with embodiments, any trace source related to a static PDID can be decoded backwards. That is, with a second decoding step, messages received prior to the PDID in clear text also can be decoded. Instead if the PDID is flexible, the traces prior receiving the PDID cannot be decoded and are discarded.

In an embodiment, the PDID messages contain packet length information (e.g., in nibbles), a predefined type information, an indication as to when the trace source does dynamic ID assignments, some reserved fields and the actual payload.

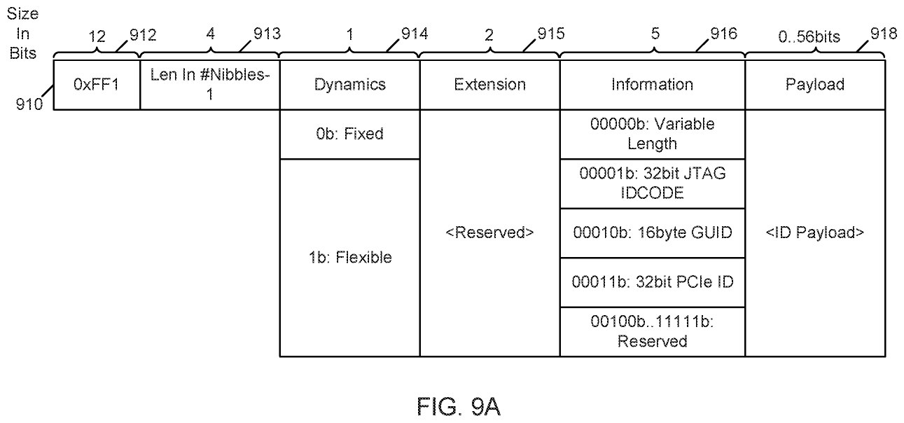

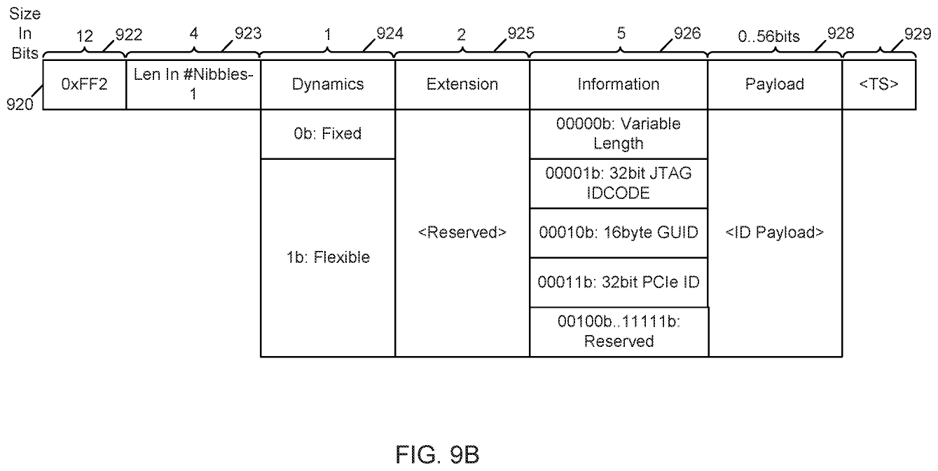

Referring now to FIG. 9A, shown is a data format of a PDID message in accordance with an embodiment of the present invention. As illustrated in FIG. 9A, PDID message 910 includes an opcode field 912 to identify the message type, a length field 913 to identify a length of the PDID message, a dynamic field 914 to indicate whether the PDID (and thus the corresponding trace source) is dynamic (e.g., trace messages change dynamically as OS applications) or fixed, an extension field 915 which may be reserved, an information field 916 to identify the type of information included in the PDID message (e.g., a JTAG code, a GUID, a PCIe ID, or so forth), and a payload field 918 that includes the actual identifier payload. If the PDID message is sent on Master ID/Channel ID 0/0, it is a global ID. As the MIPI ASYNC message sets the master and channel ID to zero, it is clear that a PDID following immediately is a global ID.

Referring now to FIG. 9B, shown is a data format of a PDID timestamp message in accordance with an embodiment of the present invention. PDID timestamp message 920 may generally include the same fields and information (with a different opcode in opcode field 922). And, following a payload field 928, a timestamp field 929 is present that is to provide the given timestamp.

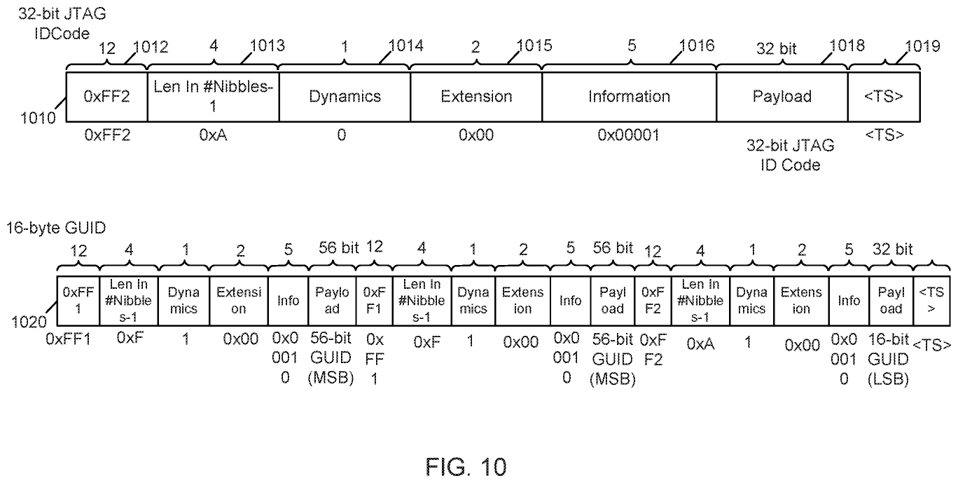

Referring now to FIG. 10, shown are example PDID messages 1010, 1020 that may be used to communicate different types of identifiers, namely a 32-bit JTAG ID code (in PDID 1010) and a 16-byte GUID (in PDID 1020). With this method, a 32-bit global JTAG IDCode can be sent on MID/CID 0/0 as in message 1010 below in message 1020. A 16-byte GUID can be constructed by 3 messages, where the last is marked by a time-stamp, also shown in FIG. 10. Understand of course that other implementations for communicating such messages are possible.

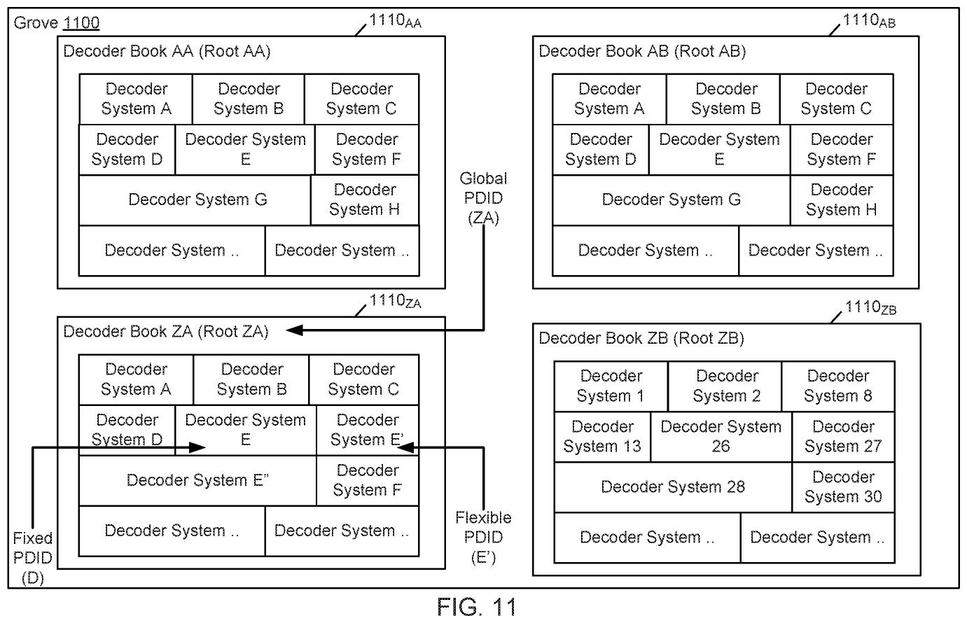

Referring now to FIG. 11, shown is a block diagram of a decoder structure in accordance with an embodiment. This decoder structure may be stored in a given non-transitory memory such as may be present or associated with a debug and test system. As illustrated in FIG. 11, decoder structure 110₀ is a hierarchical decoder, referred to herein as a grove, that includes a plurality of separate decoder books 1110_{AA, AB, ZA}, and _{ZB}. Each such decoder book 1110 acts as a root. In turn, each decoder book may be accessed using a given global PDID. When such global PDID is received, a given global book 1110 is accessed. Then, based on received local PDIDs, given decoder subsystems (each associated with a local PDID) may be accessed to provide appropriate decoder information for decoding trace messages associated with a particular trace source. Understand while shown at this high level in the embodiment of FIG. 11, many variations and alternatives are possible.

With embodiments, tracing may be performed to efficiently enable decoding of traces from complex platforms. While in some cases it may not be possible to decode every single trace in a real dynamic system, as costs would be too high to have a unique 1:1 trace-to-decoder relationship. But with an embodiment having a tiered approach (root, stem, branch), efficient decoding of a dynamic system can be performed with reduced complexity, overhead, and bandwidth. Thus debugging may be performed more efficiently, realizing quicker identification of problems in a debugged system, and reducing time to market in development of SoCs and systems implementing such SoCs.

With virtualization, resources of a computing system may be dynamically and flexibly allocated to different virtualization environments (VEs). Such virtualization environments, also called guests, typically include an operating system (OS) instance on which one or more applications within the guest execute. A given platform may have multiple VEs instantiated and in execution concurrently, with each of the VEs using shared hardware resources of the system. While the VEs share these resources, each underlying VE believes it has sole ownership and access to the hardware resources.

Virtualization is typically controlled via an orchestration layer such as a given supervisor software, e.g., a virtual machine monitor (VMM), hypervisor, docker engine, containerization engine or similar. While virtualization enables greater and more efficient consumption of hardware resources, it adds another level of complexity into the overall system firmware/software and hardware architecture, increasing challenges. With embodiments herein, a debugging system may be configured to operate within a virtualization environment, thus providing debugging capabilities like tracing to achieve high-quality products while keeping time to market low.

In embodiments, a debug system may be configured to define a standardized way to inform debug tools during runtime about the actual existence of one or more virtualized environments using a PDID in accordance with an embodiment. To this end, a VE controller (such as a hypervisor), which allocates and assigns hardware resources dynamically to guests, may configure these PDIDs. The guests themselves do not need to have any knowledge about virtualization, and therefore not represent in their now virtualized system-level manifests about that fact. Stated another way, a guest sees the hardware trace infrastructure and assumes sole ownership.

As such, embodiments enable tracing-based triage and debug methodologies in virtualized environments. More specifically, with embodiments a more reliable and higher quality output may be provided to trace analysis tools. Still further, embodiments may reduce the risk of totally unusable data. As such, embodiments may enable within a virtualization environment, sporadic captured traces of in-field failures, allowing greater debug capabilities in such systems.

Understand that with virtualization, data isolation and hardware transparency are key features. Specifically, data isolation is a fundamental principle of virtualization to ensure that there is no leakage of any data from one VE into any other VE. And as to hardware transparency, it is expected that a system running within a VE has the illusion that it runs on real hardware, and not on a virtualized surrogate of it.

With a conventional trace merging unit or trace aggregator, trace data obtained from within a system is aggregated on a system-wide level. However, note that there are trace sources that could be isolated within a VE. But some cannot due to the nature of that trace source or the functional block's role in the overall system, its architecture or its implementation. To further illustrate, examples of traces that can be isolated per VE include: software traces either from the OS or applications (e.g., ETW, Linux printk( ) or ftrace, MIPI SyS-T) are typically bound to the VE on which the software is running. Since the software itself has no exposure to any data outside their VE, software cannot expose anything via software (instrumentation) based trace; or hardware traces like Intel® Processor Trace (PT) that are designed to isolate (and control) their exposed data within a VE. As used herein, the terms “trace aggregator” or “trace merging unit” “trace merging hardware” or the like refer to any kind of trace merging unit such as a MIPI System Trace Module or ARM System Trace Macrocell, as 2 examples.

Examples of traces that typically cannot be isolated per VE include: traces of firmware blocks that service global functions of the system like a power-management controller of an SoC; low level hardware signal traces from IP block's internal design that are shared between VEs; and hardware bus (transaction) traces.

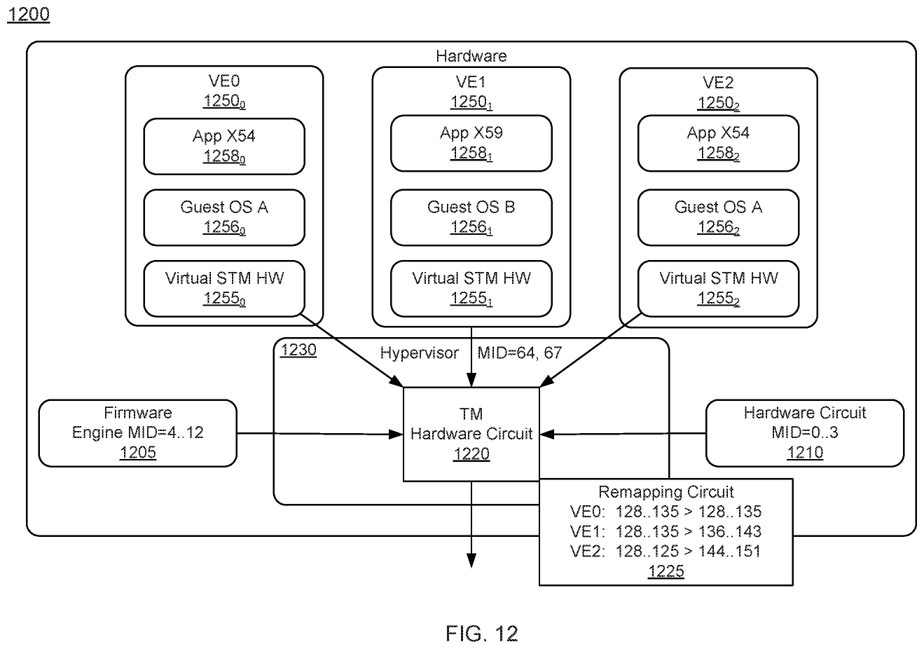

Since different system implementations may include different system hardware and software architecture design choices, there may be different trace merging implementations. Referring now to FIG. 12, shown is a block diagram of a system in accordance with another embodiment of the present invention. As shown in FIG. 12, system 1200 may be any type of computing platform that provides for virtualization capabilities. In the embodiment shown, system 1200 includes a firmware engine 1205 and at least one hardware circuit 1210. While embodiments are not limited in this regard, as an example hardware circuit 1210 may be a bus observer, embedded logic analyzer, signal viewer, finite state machine, collection of such components or other such certain hardware circuitry. Each of these components may be associated with a given master ID range. For example, in the illustration, hardware circuit 1210 is associated with master ID range 0 . . . 3 and firmware engine 1205 is associated with master ID range 4 . . . 12. With these fixed master ID ranges, firmware engine 1205 and hardware circuit 1210 may send corresponding PDIDs and trace messages to a trace merging (TM) hardware circuit 1220. In an embodiment, TM hardware circuit 1220 may be implemented as a trace aggregator, such as described herein. While fixed master ID ranges for these static elements is possible, such fixed master IDs may not be suitable for virtualization purposes.

As illustrated, system 1200 also includes a hypervisor 1230 that acts as an orchestrator for virtualization activities in platform 1200. In operation, hypervisor 1230 may instantiate multiple virtualization environments, namely virtualization environments 1250₀-1250₂. Each virtualization environment 1250 may include a guest operating system 1256₀₋₂ on which one or more applications may execute. As shown, within each virtualization environment 1250 an example application 1258₀₋₂ may be in execution.

Virtualization environments 1250_{0,2} may be of the same type, e.g., same OS, and virtualization environment 1250₁ may be of a different OS. For example, assume that virtualization environments 1250_{0,2} may be used to execute a feature rich graphical oriented OS such as a Windows™ OS and virtualization environment 1250₁ may be used to execute a real time OS. And as further shown the same application 1258_{0,2} (app X54) may execute on virtualization environments 1250_{0,2}.

With many virtualization arrangements, each virtualization environment operates under the illusion that it owns the underlying hardware and is the only environment within the system. With respect to trace activities described herein, each virtualization environment 1250 believes that it has sole ownership and access to, inter alia, TM hardware circuit 1220. Thus as further shown in FIG. 12, each virtualization environment 1250 includes a virtual TM hardware circuit 1255₀₋₂. Understand however that there is no physical hardware in the guests, and instead circuit 1255 shows a conceptual view of a guest assumption that it owns TM hardware circuit 1220. Note that each of these virtual TM hardware circuits is provided with the same master ID range, namely 128 . . . 135. As such, each guest OS 1256₀₋₂, when it is sending trace messages (and PDID messages) writes to the same local master ID range of 128 . . . 135 to identify the trace source.

To accommodate this, hypervisor 1230 may include or be associated with a remapping circuit 1225, which acts to remap this common or single master ID range allocated to all virtualization environments into multiple master ID ranges, each associated with one of the virtualization environments. More generally, remapping circuit 1225 may be implemented as a unit that may leverage an IOMMU. In other embodiments, hypervisor 1230 may include remapping logic to perform this remapping. As seen, virtualization environment 1250₀ may maintain the original master ID (MID) range mapping of 128 . . . 135. In turn, virtualization environment 1250₁ may have its master ID range remapped from 128 . . . 135 to 136 . . . 143. And virtualization environment 1250₂ may have its master ID range remapped from 128 . . . 135 to 144 . . . 151. Although shown at this high level in the embodiment of FIG. 12, many variations and alternatives are possible.

To enable tracing in virtualization contexts, a hypervisor or other orchestration component may appropriately map a single PDID that is associated with all virtualization environments into separate or nested virtualized PDID name spaces. Stated another way, these global-scope PDIDs may be bound only to a given sub-range of a physical master-channel space and may be associated with a single virtualization environment.

There are several different trace topologies and use cases possible which will have different impact on what can be traced by VE and non-VE related components of the system, and what are the implications or requirements for an TM. In the embodiment of FIG. 12, there is one physical TM in the system. The output from TM hardware circuit 1220 can contain data from any virtualized environment 1250 at the same time.

Hypervisor 1230, which acts as a virtualization orchestrator, could expose the TM to one or more VEs 1250 at the same time. In this case VEs 1250_{0 . . . 2} see a virtualized version of the real TM hardware, because none of them own this hardware resource. In this case “ownership” means that VEs 1250_{0 . . . 2} are not allowed to change the configuration of TM hardware circuit 1220, because that would have a system-wide impact on the trace configuration for all other VEs.

Therefore, hypervisor 1230 isolates the access from VEs 1250_{0 . . . 2} to configuration logic of TM hardware circuit 1220. Instead, hypervisor 1230 may control access such that VEs 1250_{0 . . . 2} are allowed only to send trace data into TM hardware circuit 1220.

A consequence of the hardware transparency principle of VEs is that in case of an TM implementing the MIPI STP protocol (other wrapping protocols such as ARM TWP can use the same mechanism), each VE may be assigned with a separate physical master/channel (basically an independent trace address space) space. However, since the VEs themselves are not aware of their virtualization, the master ID/channel IDs (MID/CIDs) exposed to a VE are virtual MID/CIDs. Stated another way, each VE 1250_{0 . . . 2} may be configured to send trace messages to the same logical location (e.g., master and channel). In turn, hypervisor 1230 may include or be associated with remapping circuitry 1225 to remap this same MID/CID value to an individual MID/CID value for a given VE.

As such, hypervisor 1230 may be configured to provide a virtual MID/CID to VEs 1250_{0 . . . 2} and translate this single virtual MID/CID value to corresponding physical MID/CID values for communication to TM hardware circuit 1220. Stated another way, each VE 1250_{0 . . . 2} sends a local or virtual master ID and hypervisor 1230 remaps or translates this local master ID range into a plurality of global master ID ranges.

Data isolation of a VE implies that the owner (or instance of controlling hypervisor) of TM hardware circuit 1220 is empowered to see everything in the system. This empowering might imply that VEs 1250_{0 . . . 2} be provided with the option to: a) not use tracing at all, because they are not willing to empower anyone, or b) refuse to be launched at all, as they consider that there is no safe way to ensure that none of their considered private data is leaking out. A variant is that there is one privileged VE, which is in control of the TM, and as such has full control.

In other implementations, an isolated VE trace configuration may be provided in which a TM is exclusively assigned to a VE, such that the VE has full control of the TM. Per the data isolation principle of virtualization, there are no traces routed to this TM that contain any non-VE data. However, such configuration may cause complications, because there might be trace sources that violate this data isolation principle.

To this end, an orchestrator such as a hypervisor may disable certain functional blocks in the TM before it hands over control to the VE. In such implementation, the hypervisor may physically own the TM hardware and perform its configuration. In another implementation, there may be a special version (e.g., smaller) of an TM that is not able to receive any non-VE private data. One example is to only allow software running within the VE to send traces via a software instrumentation method such as a MIPI SyS-T implementation to this TM.

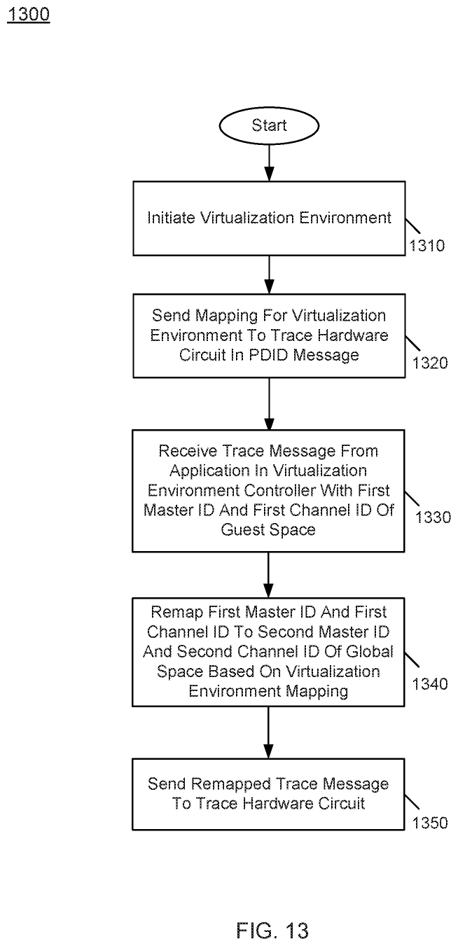

Referring now to FIG. 13, shown is a flow diagram of a method in accordance with another embodiment of the present invention. As shown in FIG. 13, method 1300 is a method for controlling a virtualization environment. Method 1300 may be performed by a hypervisor or other orchestration component, which may execute using hardware circuitry, firmware, software and/or combinations thereof. As illustrated, method 1300 begins by initiating a virtualization environment (block 1310). For example, the hypervisor may instantiate a given virtualization environment that includes a guest OS (e.g., a Windows™-based OS as an example) on which one or more applications execute. In instantiating this virtualization environment, understand that the hypervisor may indicate the presence of various hardware that the OS believes it has sole access to. In addition to cores, graphics processors, accelerators, memory and so forth, such hardware may further include a trace wrapping machine (implemented in hardware, software or a combination), which is thus virtualized for use by this virtualization environment.

In addition to initiating the virtualization environment, the hypervisor may prepare and send a mapping for the virtualization environment to a trace hardware circuit (block 1320). More specifically, this mapping may be included in a PDID or similar message that identifies a sub-range of a physical master/channel space allocated to this virtualization environment. Details of this mapping are described further below.

Next, at block 1330 during normal operation the hypervisor may receive a trace message from the application. This trace message sent from the virtualization environment may include a first master ID and a first channel ID of the guest space. As discussed above, this first master ID/channel ID may be the same master ID/channel ID used by other virtualization environments, as each virtualization environment believes it has sole access to underlying hardware including the trace hardware circuit.

Next at block 1340 the hypervisor or other VE controller may remap this first master ID/channel ID to a second master ID and a second channel ID of a global space. Such remapping may be based on the mapping for the virtualization environment, performed in block 1320 discussed above. Note that it is possible that the remapping is only for master ID; that is, it is possible for a channel ID received from a virtualization environment to be unchanged during remapping.

Finally at block 1350 the hypervisor may send the remapped trace message to the trace hardware circuit. Understand that similar operations may occur in the hypervisor responsive to receipt of a PDID message from a virtualization environment, to remap the common or virtual MID of the PDID message to a physical master/channel space, as well as providing additional information such as described in block 1320. With this information, the trace hardware circuit may send these messages to a debug and test system to enable it to access an appropriate decoder to enable decoding of the trace message. Note that the debug and test system may be an external tool capturing the trace stream, performing the decoding and visualization. In other cases, the debug and test system could be implemented in the target itself. Understand while shown at this high level in the embodiment of FIG. 13, many variations and alternatives are possible.

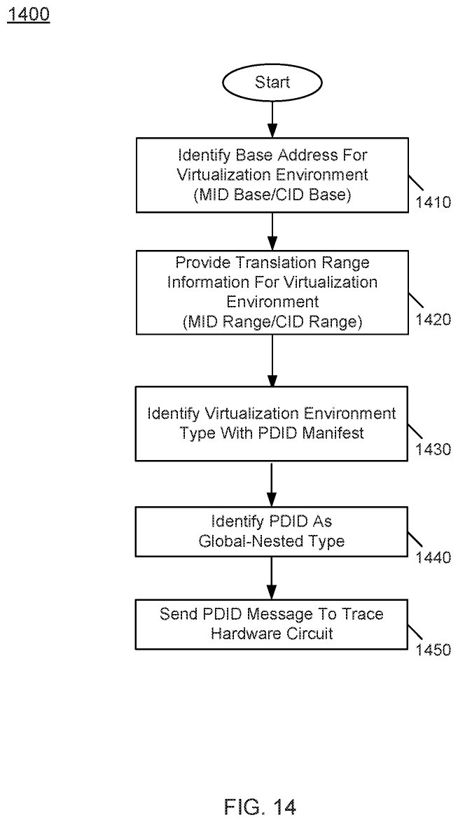

Referring now to FIG. 14, shown is a flow diagram of a method in accordance with yet another embodiment of the present invention. As shown in FIG. 14, method 1400 is a method for preparing and sending a global-nested PDID message for a virtualization environment. Method 1400 may be performed at least in part by a hypervisor or other orchestration component, which may execute using hardware circuitry, firmware, software and/or combinations thereof.

As illustrated, method 1400 begins by identifying a base address for a virtualization environment (block 1410). More specifically, this base address may be set to a master ID base and a channel ID base. In embodiments herein, note that for each virtualization environment, this base address may be set to different values, at least for MID base values. It is possible for multiple virtualization environments to have the same CID base value. Assume for a first virtualization environment, its base values may be set to a MID base value of 128 and a CID base value of 0. In general, the idea is to not have a conflict. MID/CID basically defines an address, and the hypervisor ensures that there is no overlap on the addresses. Therefore, the hypervisor changes MIDs or CIDs or both (logical-to-physical translation).

Next at block 1420 translation range information may be provided for the virtualization environment. More specifically, this translation range may be of the form of a MID range and CID range. As an example, this MID range may be set to 7 and the CID range may be set to 255. With these base and range values, base and maximum MID/CID values for the virtualization environment may be determined.

Still with reference to FIG. 14, at block 1430 a virtualization engine type may be identified with a PDID manifest. For example, each of multiple PDID manifests may be available, each to be associated with a given virtualization environment type. Next at block 1440 the PDID may be identified as a global-nested type. In an embodiment, a scope field of a header of the PDID may be used to identify this PDID is a global-nested type with MID/CID affine. Finally at block 1450 this PDID message may be sent to a trace hardware circuit. As described herein, the trace hardware circuit may pass this PDID message along to a debug and test system, to enable identification of an appropriate decoder for purposes of decoding incoming trace messages from this virtualization environment. While shown at this high level in the embodiment of FIG. 14, many variations and alternatives are possible.

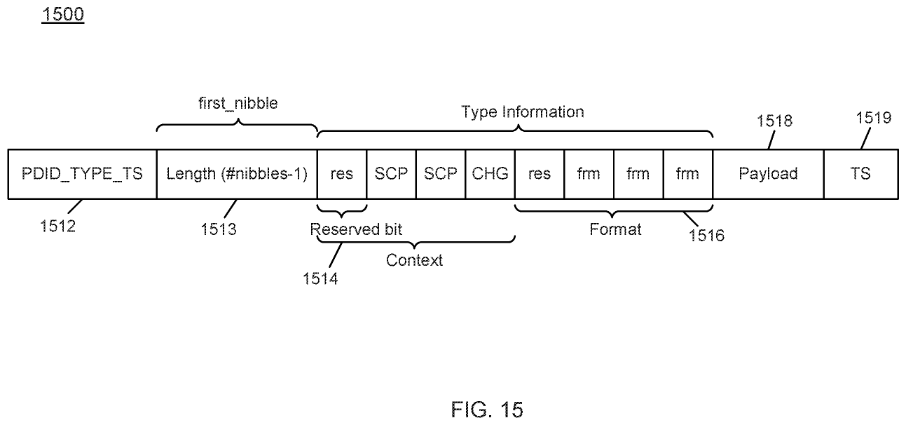

Referring now to FIG. 15, shown is a format for a PDID packet in accordance with an embodiment. As illustrated in FIG. 15, PDID message 1500 includes an opcode field 1512 to identify the message type, a length field 1513 to identify a length of the PDID message, a context field 1514 including a scope field to store a value to identify a scope of the PDID type (as discussed below in Table 1), a format field 1516 to identify format information, a payload field 1518 that includes the actual identifier payload, and a timestamp field 1519 is present to provide a timestamp.

With embodiments, a system-wide trace configuration topology is provided using a globally-nested PDID. This is so, since even if all VEs' trace sources were to use only globally-unique IDs for any of their trace sources (e.g., 128-bit GUID), a single combined system-level manifest would still be present to describe all the trace sources. However, determining which VEs and what software within these VEs is executed, and therefore what kind of trace sources on which MID/CIDs are sent, would be decided during runtime, and not statically known.

Thus PDID namespaces are nested or virtualized. These PDID namespaces are identified by a global-scope PDID but bound only to a sub-range of a physical master/channel space. In contrast, conventional global-scope PDIDs are assigned to an entire TM block output.

To realize this arrangement of PDID namespaces, a scope field of a PDID header (PDID_TYPE_TS.SCP) may be used to provide the following information in Table 2.

TABLE 2

| SCP value | Scope |
|---|---|
| 00 | global, not MID/CID affine |
| 01 | local, MID/CID affine |
| 10 | global-nested, MID/CID affine |
| 11 | Reserved |

As shown, the above encoding of b′10 ‘global-nested, MID/CID affine’ identifies the PDID message as only affecting the PDID namespace of a master/channel range defining this PDID message.

In one embodiment, a MID/CID range for a global-nested PDID as in FIG. 15 may be encoded in the PDID message as follows. The MID/CID of this PDID message is the start of the range. A 32-bit value in front of the PDID value defines the end of the range, where the 32-bits are divided into 2×16-bit values of 16-bits master-range and 16-bits end-channel-offset. If the master-range is >0, then the end-channel-offset is not added to the channel-number of the PDID message to define the end-of-range channel number.

Note that offsets may be used, because in case of nested VEs, the orchestrator, which assigns MID/CID ranges to nested VEs, already operates on virtualized MID/CID-numbers itself.

With reference back to FIG. 12, assume that:

Application App X54 in VE0 sends trace messages on (VE0 virtual) MID 128/CID 10;

Application App X59 in VE1 sends trace messages on (VE1 virtual) MID 128/CID 10; and

Application App X54 in VE2 sends trace messages on (VE2 virtual) MID 128/CID 10.

Both VE0 and VE2 are running the same type of VE, while VE1 is another type. There may be 2 STP PDID manifests identified via <GUID-defining-VE-type-XYZ > and <GUID-defining-VE-type-DEF >. More specifically, a first manifest <GUID-defining-VE-type-XYZ > defines the App X54 trace is sent to MID 128/CID 10. In turn, a manifest <GUID-defining-VE-type-DEF > defines that App X59 trace is sent to MID 128/CID 10. As seen, these manifests have no information about virtualization, and may be used in any non-virtualized environment exactly the same way as in a virtualized environment.

Referring now to Table 3, shown are example operations performed by an orchestration component such as a hypervisor to instantiate multiple virtualization environments and provide mapping information by way of a PDID message to a TM component, to enable the TM component to dynamically add metadata to incoming trace messages from the different VEs. Understand while shown with these particular examples in Table 3, many variations and alternatives are possible.

TABLE 3
Example of an STP packet flow:
1) Hypervisor starts VE0 and sends mapping for VE0 to the TM.
//The STP PDID message is sent on MID_{base}/CID_{base} = 128/0 (base address of VE0),
indicating first the translation range MID_{range}/CID_{range} = 7/255, resulting in the maximum
MIDₘₐₓ/CIDₘₐₓ = MID_{base}/CID_{base} + MID_{range}/CID_{range} = 135/255.
The GUID VE-type-XYZ is describing the range of VE0.

| M16 (128) | C16 (0) | PDID_DATA(7,255) | //length hidden. Ranges are |
|---|---|---|---|
| Master Base | Channel Base | MID range = 7 | 128/0 . . . 135/255 |
| | | CID range = 255 | |

PDID_DATA(<GUID-defining-VE-type-XYZ>)
PDID_TYPE_TS(SCP = global-nested, fmt = GUID)
2) App X54 is running in VE0 and sends a trace message-A on (VE0 virtual) MID
128/CID 10.
Thus the hypervisor remaps trace message A to M16 (128) C16(10) Dx(<message-A>).
3) Hypervisor starts VE1 and sends mapping for VE1 to the TM.
//The STP PDID message is sent on MID_{base}/CID_{base} = 136/0 (base address of VE1),
indicating first the translation range MID_{range}/CID_{range} = 7/255 resulting in the maximum
MIDₘₐₓ/CIDₘₐₓ = MID_{base}/CID_{base} + MID_{range}/CID_{range} = 143/255. The GUID VE-type-
DEF is describing the range of VE1.

| M16 (136) | C16 (0) | PDID_DATA(7,255) | |
|---|---|---|---|
| Master Base | Channel Base | MID range = 7 | //ranges are 136/0 . . . 143/255 |
| | | CID range = 255 | |

PDID_DATA(<GUID-defining-VE-type-DEF>)
PDID_TYPE_TS(SCP = global-nested, fmt = GUID)
4) App X59 is running in VE1 and sends a trace message-B on (VE1 virtual) MID
128/CID 10.
Thus the hypervisor remaps trace message A to M16 (136) C(10) Dx(<message-B>).
5) Hypervisor starts VE2 and sends mapping for VE2 to the TM.
//The STP PDID message is sent on MID_{base}/CID_{base} = 144/0 (base address of VE2),
indicating first the translation range MID_{range}/CID_{range} = 7/255 resulting in the max
MIDₘₐₓ/CIDₘₐₓ = MID_{base}/CID_{base} + MID_{range}/CID_{range} = 151/255. The GUID VE-type-
XYZ is describing the range of VE2.
M16 (144) C16(0) PDID_DATA(7,255)//ranges are 144/0 . . . 151/255
PDID_DATA(<GUID-defining-VE-type-XYZ>)
PDID_TYPE_TS(SCP = global-nested, fmt = GUID)
Note that VE2 is of the same type as VE0.
6) App X54 is running in VE2 and sends a trace message-A on (VE2 virtual) MID
128/CID 10.
Thus the hypervisor remaps trace message A to M16 (144) C(10) Dx(<message-A>).

As seen, the two instances of App X54 are sent from the VE controller to a TM hardware circuit on different physical MID numbers without any need for App X54 to be aware of that fact. This is so, since the VE controller (e.g., hypervisor) maintains a translation from the guest MID/CID space into the global MID/CID space through a second level address translation (SLAT).

Further note that a trace receiver such as a debug and test system (not shown in FIG. 12) does not need to be aware of the details of the mechanism, e.g., how channels are assigned. The tracing tool receives enough information embedded in the trace stream to properly decode traces from any application running on the guest.

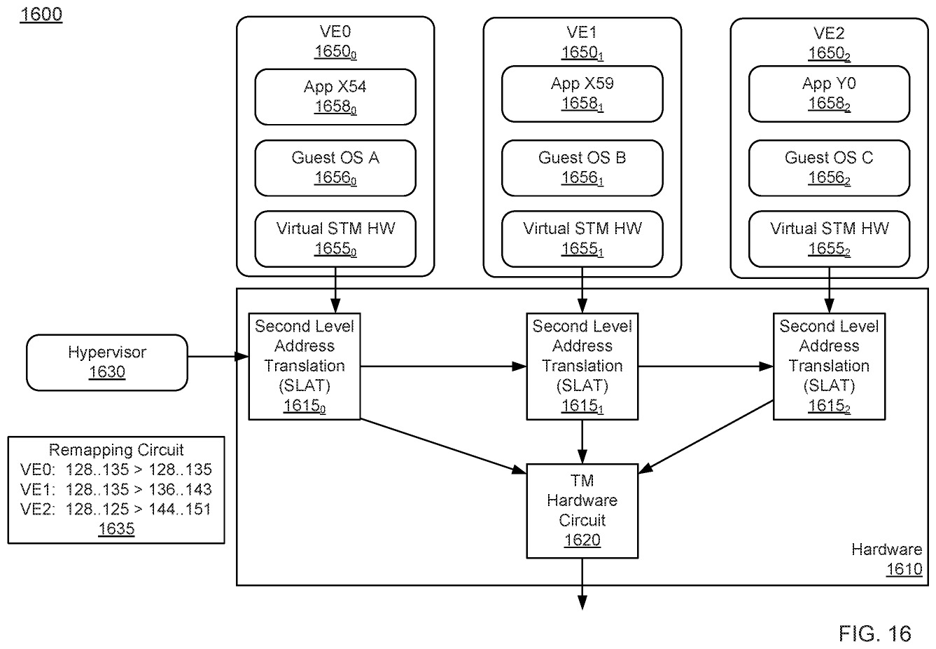

Referring now to FIG. 16, shown is a block diagram of a system in accordance with another embodiment of the present invention. As shown in FIG. 16, system 1600 may be implemented generally the same as system 1200 of FIG. 12, namely a system configured to operate with virtualization by way of a hypervisor 1630 and multiple virtualization environments 1650_{0,2}. Note that like components as FIG. 12 are not described here as they may operate the same as discussed above in FIG. 12 (for components including the same numerals, albeit of the “1600” series).

As illustrated, hypervisor 1630 may include or be associated with a remapping circuit 1635 to perform MID translations from a global MID range to sub-ranges of a physical MID space. As further illustrated, additional hardware within system 1600 may include a set of second level address translation circuits (SLATs) 1615₀₋₂, each of which may be configured by hypervisor 1630. In turn, each of these SLATs 1615 may remap incoming trace messages from corresponding virtualization environments 1650 to remapped MID's based on configuration by hypervisor 1630. As such, PDIDs are sent to TM hardware circuit 1620 in different MID ranges to distinguish between different virtualization environments 1650. Understand while shown at this high level in the embodiment of FIG. 16, many variations and alternatives are possible.

Embodiments thus enable transparent support of tracing in VEs using MIPI STP protocol-based trace aggregation solutions (like Intel® Trace Hub). The information used to distinguish different instances of VEs may be generated by a VE controlling instance (e.g., hypervisor). With embodiments, debug and trace technologies are provided, even where a system runs within a virtualized environment. Still further debugging issues may be supported due to unexpected effects of virtualization.

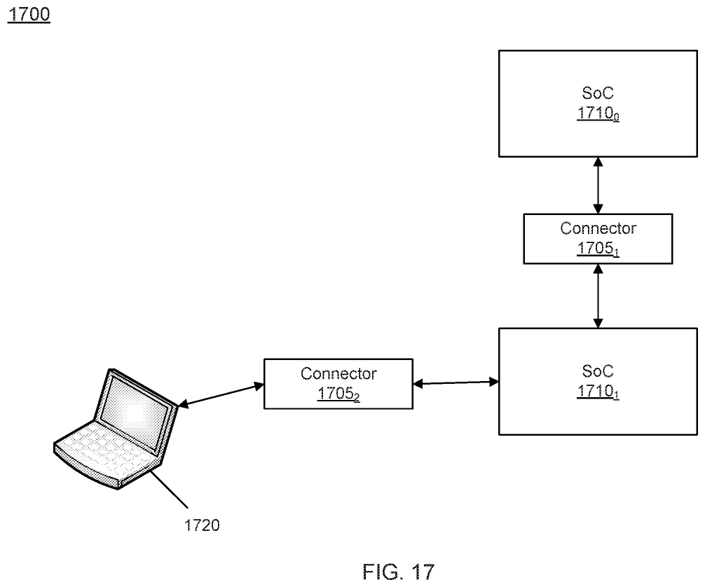

Referring now to FIG. 17, shown is a block diagram of a system in accordance with another embodiment. As shown in FIG. 17, system 1700 includes multiple SoC's 1710_{1,2}. In a given implementation each SoC 1710 may be configured similar to SoC 1610 of FIG. 16. As such, virtualization environments are present. As one example, SoC 1710₁ may be present on a plug-in card or soldered down on a motherboard. As one example, SoC 1710₁ may couple to SoC 1710 via a connector 1705₁ in which the communication is via a PCIe link. And internal to SoC 1710, connector 1705₁ may couple to a given one of multiple SLATs, to enable remapping to be performed as described herein. With this arrangement, each SoC 1710 includes a TM, and both SoC's may have hypervisors.

In one example, the hypervisor of one SoC is unaware of the presence of another hypervisor in the other SoC. And as further illustrated, SoC 1710 may couple via another connector 1705₂ to a debug and test system 1720. With this or a similar arrangement, a configuration as in FIG. 17 may build a tree structure.

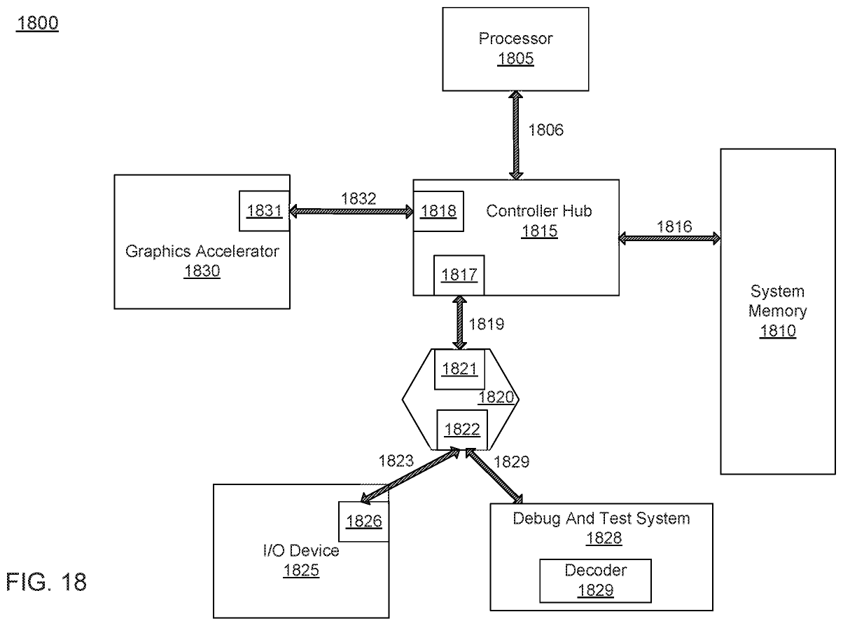

Embodiments may be implemented in a wide variety of systems. Referring to FIG. 18, an embodiment of a fabric composed of point-to-point links that interconnect a set of components is illustrated. System 1800 includes processor 1805 and system memory 1810 coupled to a controller hub 1815. Processor 1805 includes any processing element, such as a microprocessor, a host processor, an embedded processor, a co-processor, or other processor. Processor 1805 is coupled to controller hub 1815 through front-side bus (FSB) 1806. In one embodiment, FSB 1806 is a serial point-to-point interconnect. In an embodiment, where processor 1805 and controller hub 1815 are implemented on a common semiconductor die, bus 1806 may be implemented as an on-die interconnect. In yet another implementation where processor 1805 and controller hub 1815 are implemented as separate die within a multi-chip package, bus 1806 can be implemented as an intra-die interconnect.

System memory 1810 includes any memory device, such as random access memory (RAM), non-volatile (NV) memory, or other memory accessible by devices in system 1800. System memory 1810 is coupled to controller hub 1815 through memory interface 1816. Examples of a memory interface include a double-data rate (DDR) memory interface, a dual-channel DDR memory interface, and a dynamic RAM (DRAM) memory interface.

In one embodiment, controller hub 1815 is a root hub, root complex, or root controller in a PCIe interconnection hierarchy. Examples of controller hub 1815 include a chipset, a peripheral controller hub (PCH), a memory controller hub (MCH), a northbridge, an interconnect controller hub (ICH), a southbridge, and a root controller/hub. Often the term chipset refers to two physically separate controller hubs, i.e. a memory controller hub (MCH) coupled to an interconnect controller hub (ICH). Note that current systems often include the MCH integrated with processor 1805, while controller 1815 is to communicate with I/O devices, in a similar manner as described below. In some embodiments, peer-to-peer routing is optionally supported through root complex 1815.

Here, controller hub 1815 is coupled to switch/bridge 1820 through serial link 1819. Input/output modules 1817 and 1821, which may also be referred to as interfaces/ports 1817 and 1821, include/implement a layered protocol stack to provide communication between controller hub 1815 and switch 1820. In one embodiment, multiple devices are capable of being coupled to switch 1820.

Switch/bridge 1820 routes packets/messages from device 1825 upstream, i.e., up a hierarchy towards a root complex, to controller hub 1815 and downstream, i.e., down a hierarchy away from a root controller, from processor 1805 or system memory 1810 to device 1825. Switch 1820, in one embodiment, is referred to as a logical assembly of multiple virtual PCI-to-PCI bridge devices. Device 1825 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, and other input/output devices and which may be coupled via an I3C bus, as an example. Often in the PCIe vernacular, such a device is referred to as an endpoint. Although not specifically shown, device 1825 may include a PCIe to PCI/PCI-X bridge to support legacy or other version PCI devices. Endpoint devices in PCIe are often classified as legacy, PCIe, or root complex integrated endpoints.

As further illustrated in FIG. 18, another device that may couple to switch/bridge 1820 is a debug and test system 1828 to perform decoding using PDIDs to access decoder subsystems of (potentially) multiple decoder books present in a decoder 1829.

Graphics accelerator 1830 is also coupled to controller hub 1815 through serial link 1832. In one embodiment, graphics accelerator 1830 is coupled to an MCH, which is coupled to an ICH. Switch 1820, and accordingly I/O device 1825, is then coupled to the ICH. I/O modules 1831 and 1818 are also to implement a layered protocol stack to communicate between graphics accelerator 1830 and controller hub 1815. A graphics controller or the graphics accelerator 1830 itself may be integrated in processor 1805.

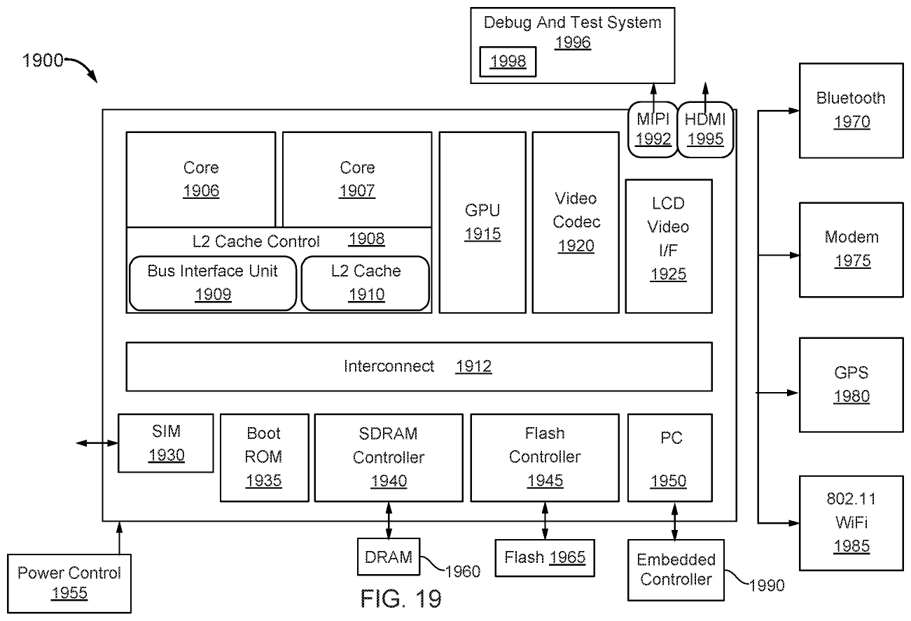

Turning next to FIG. 19, an embodiment of a SoC design in accordance with an embodiment is depicted. As a specific illustrative example, SoC 1900 may be configured for insertion in any type of computing device, ranging from portable device to server system. Here, SoC 1900 includes 2 cores 1906 and 1907. Cores 1906 and 1907 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 1906 and 1907 are coupled to cache control 1908 that is associated with bus interface unit 1909 and L2 cache 1910 to communicate with other parts of system 1900 via an interconnect 1912.

Interconnect 1912 provides communication channels to the other components, such as a Subscriber Identity Module (SIM) 1930 to interface with a SIM card, a boot ROM 1935 to hold boot code for execution by cores 1906 and 1907 to initialize and boot SoC 1900, a SDRAM controller 1940 to interface with external memory (e.g., DRAM 1960), a flash controller 1945 to interface with non-volatile memory (e.g., flash memory 1965), a peripheral controller 1950 (e.g., via an eSPI interface) to interface with peripherals, such as an embedded controller 1990.

Still referring to FIG. 19, system 1900 further includes video codec 1920 and video interface 1925 to display and receive input (e.g., touch enabled input), GPU 1915 to perform graphics related computations, etc. In addition, the system illustrates peripherals for communication, such as a Bluetooth module 1970, 3G modem 1975, GPS 1980, and WiFi 1985. Also included in the system is a power controller 1955. Further illustrated in FIG. 19, system 1900 may additionally include interfaces including a MIPI interface 1992 to couple to, e.g., a debug and test system 1996 including a decoder 1998 configured to operate as described herein, and/or an HDMI interface 1995 which may couple to a display.

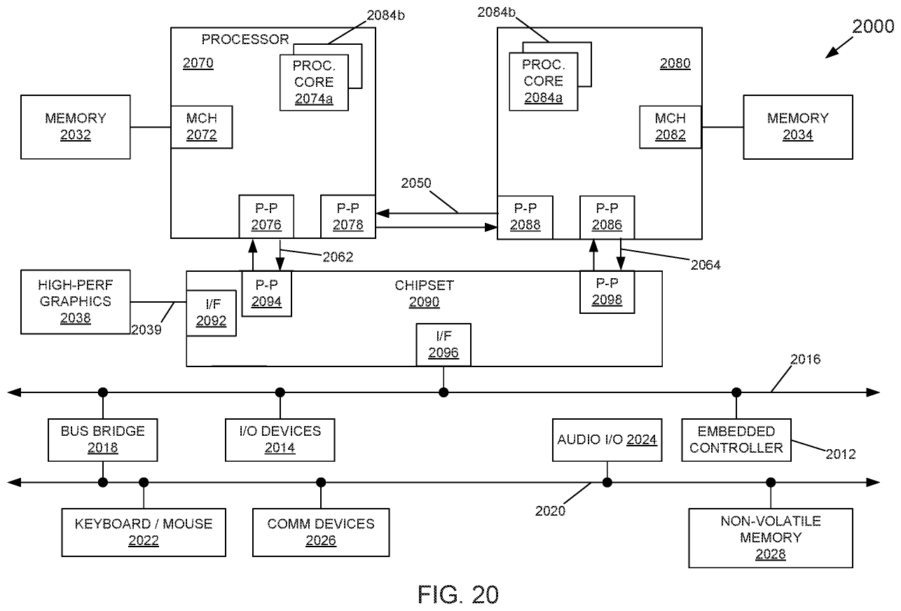

Referring now to FIG. 20, shown is a block diagram of a system in accordance with an embodiment of the present invention. As shown in FIG. 20, multiprocessor system 2000 includes a first processor 2070 and a second processor 2080 coupled via a point-to-point interconnect 2050. As shown in FIG. 20, each of processors 2070 and 2080 may be many core processors including representative first and second processor cores (i.e., processor cores 2074a and 2074b and processor cores 2084a and 2084b).

Still referring to FIG. 20, first processor 2070 further includes a memory controller hub (MCH) 2072 and point-to-point (P-P) interfaces 2076 and 2078. Similarly, second processor 2080 includes a MCH 2082 and P-P interfaces 2086 and 2088. As shown in FIG. 20, MCH's 2072 and 2082 couple the processors to respective memories, namely a memory 2032 and a memory 2034, which may be portions of system memory (e.g., DRAM) locally attached to the respective processors. First processor 2070 and second processor 2080 may be coupled to a chipset 2090 via P-P interconnects 2062 and 2064, respectively. As shown in FIG. 20, chipset 2090 includes P-P interfaces 2094 and 2098.

Furthermore, chipset 2090 includes an interface 2092 to couple chipset 2090 with a high performance graphics engine 2038, by a P-P interconnect 2039. As shown in FIG. 20, various input/output (I/O) devices 2014 and an embedded controller 2012 may be coupled to first bus 2016, along with a bus bridge 2018 which couples first bus 2016 to a second bus 2020. Various devices may be coupled to second bus 2020 including, for example, a keyboard/mouse 2022, communication devices 2026 and a non-volatile memory 2028. Further, an audio I/O 2024 may be coupled to second bus 2020. System 2000 may communicate with a debug and test system, and provide PDIDs to enable efficient debugging in a virtualization environment as described herein.

The following examples pertain to further embodiments.

In one example, an apparatus includes: a first hardware circuit to execute operations, where at least one virtualization environment to be instantiated by a virtualization environment controller is to execute on the first hardware circuit, where the virtualization environment controller is to receive a first trace message from the at least one virtualization environment and a first platform description identifier to identify the at least one virtualization environment, remap the first platform description identifier to a second platform description identifier and send the first trace message and the second platform description identifier to a trace hardware circuit; and the trace hardware circuit coupled to the first hardware circuit. The trace hardware circuit is to receive the first trace message and the second platform description identifier and send the first trace message and the second platform description identifier to a debug and test system.

In an example, the trace hardware circuit is to be virtualized for use by a plurality of virtualization environments.

In an example, each of the plurality of virtualization environments is to send the first platform description identifier to identify itself to the virtualization environment controller.

In an example, the virtualization environment controller is to generate the second platform description identifier comprising a master identifier base value, a channel identifier base value, range information to identify a range of master identifiers and channel identifiers associated with the at least one virtualization environment, and type information to define a type of virtualization environment.

In an example, the second platform description identifier comprises a scope field having a first value to indicate that the second platform description identifier comprises a global-nested platform description identifier.

In an example, the virtualization environment controller is to remap another platform description identifier received from a second virtualization environment to a third platform description identifier and send the third platform description identifier and a second trace message received from the second virtualization environment to the trace hardware circuit.

In an example, the virtualization environment controller is to remap a common master identifier of the first trace message to a second master identifier associated with the at least one virtualization environment, where the common master identifier comprises a virtual master identifier shared by a plurality of virtualization environments and the second master identifier comprises a physical master identifier.

In an example, the virtualization environment controller is to receive the first trace message having a first master identifier from a first application in execution in a first virtualization environment and receive a second trace message having the first master identifier from the first application in execution in a second virtualization environment, and send the first trace message having a second master identifier to the debug and test system and send the second trace message having a third master identifier to the debug and test system.

In an example, the apparatus further comprises a mapping circuit to remap the first master identifier to the second master identifier.

In an example, the virtualization environment controller is to receive the first trace message having a first channel identifier from the first application, and send the first trace message having a second channel identifier to the debug and test system.

In an example, the second platform description identifier is to identify presence of the at least one virtualization environment, and the first platform description identifier does not identify the presence of the at least one virtualization environment.

In an example, the second platform description identifier comprises a global-nested platform description identifier that is bound to a sub-range of a physical master/channel space.

In another example, a method comprises: instantiating, via a virtualization environment controller, a first virtualization environment to execute on one or more hardware circuits of a SoC, comprising exposing a common master identifier range to the first virtualization environment, the common master identifier range to be exposed to a plurality of virtualization environments; generating a first platform description identifier message to identify the first virtualization environment, the first platform description identifier message comprising a master identifier base value, a channel identifier base value, range information to identify a range of master identifiers and channel identifiers associated with the first virtualization environment, and type information to define a type of virtualization environment; and sending the first platform description identifier message to a debug and test system coupled to the SoC, to enable the debug and test system to identify an incoming trace message received from the first virtualization environment.

In an example, the method further comprises generating the first platform description identifier message comprising a scope field having a first value to indicate that the first platform description identifier comprises a global-nested platform description identifier.

In an example, the method further comprises: receiving, in the virtualization environment controller, a first trace message from the first virtualization environment, the first trace message comprising a first master identifier of the common master identifier range; remapping the first master identifier of the common master identifier range to a second master identifier of the range of master identifiers; and sending the first trace message having the second master identifier to the debug and test system.

In an example, the method further comprises: receiving, in the virtualization environment controller, a first trace message from a first application in execution in the first virtualization environment and a second trace message from the first application in execution in a second virtualization environment, the first trace message and the second trace message comprising a first master identifier of the common master identifier range; remapping the first trace message and the second trace message to have different master identifiers; and sending the first trace message and the second trace message having the different master identifiers to the debug and test system.

In another example, a computer readable medium including instructions is to perform the method of any of the above examples.

In a further example, a computer readable medium including data is to be used by at least one machine to fabricate at least one integrated circuit to perform the method of any one of the above examples.

In a still further example, an apparatus comprises means for performing the method of any one of the above examples.

In another example, a system comprises: a SoC that comprises at least one core to execute instructions and a trace aggregator coupled to the at least one core. The at least one core is to be virtualized to a plurality of virtualization environments, where a first virtualization environment to execute on the at least one core is to send to a virtualization controller a first trace message having a first master identifier shared with one or more other virtualization environments, where the virtualization controller is to remap the first master identifier to a second master identifier associated with the first virtualization environment and send the first trace message with the second master identifier to the trace aggregator. The system further includes a debug and test system coupled to the SoC via an interconnect, the debug and test system to receive the first trace message with the second master identifier and access a first decoder subsystem using the second master identifier for use in decoding the first trace message.

In an example, the trace aggregator is to be virtualized for use by the plurality of virtualization environments.

In an example, the virtualization controller is to generate a platform description identifier for the first virtualization environment, the platform description identifier comprising a master identifier base value, a channel identifier base value, range information to identify a range of master identifiers and channel identifiers associated with the first virtualization environment, and type information to define a type of virtualization environment.

In an example, the platform description identifier comprises a scope field having a first value to indicate that the platform description identifier comprises a global-nested platform description identifier that is bound to a sub-range of a physical master/channel space.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SoC or other processor, is to configure the SoC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a first hardware circuit to execute operations, wherein at least one virtualization environment to be instantiated by a virtualization environment controller is to execute on the first hardware circuit, wherein the virtualization environment controller is to receive a first trace message from the at least one virtualization environment and a first platform description identifier to identify the at least one virtualization environment, remap the first platform description identifier to a second platform description identifier and send the first trace message and the second platform description identifier to a trace hardware circuit; and
the trace hardware circuit coupled to the first hardware circuit, wherein the trace hardware circuit is to receive the first trace message and the second platform description identifier and send the first trace message and the second platform description identifier to a debug and test system.

2. The apparatus of claim 1, wherein the trace hardware circuit is to be virtualized for use by a plurality of virtualization environments.

3. The apparatus of claim 2, wherein each of the plurality of virtualization environments is to send the first platform description identifier to identify itself to the virtualization environment controller.

4. The apparatus of claim 3, wherein the virtualization environment controller is to generate the second platform description identifier comprising a master identifier base value, a channel identifier base value, range information to identify a range of master identifiers and channel identifiers associated with the at least one virtualization environment, and type information to define a type of virtualization environment.

5. The apparatus of claim 4, wherein the second platform description identifier comprises a scope field having a first value to indicate that the second platform description identifier comprises a global-nested platform description identifier.

6. The apparatus of claim 1, wherein the virtualization environment controller is to remap another platform description identifier received from a second virtualization environment to a third platform description identifier and send the third platform description identifier and a second trace message received from the second virtualization environment to the trace hardware circuit.

7. The apparatus of claim 1, wherein the virtualization environment controller is to remap a common master identifier of the first trace message to a second master identifier associated with the at least one virtualization environment, wherein the common master identifier comprises a virtual master identifier shared by a plurality of virtualization environments and the second master identifier comprises a physical master identifier.

8. The apparatus of claim 1, wherein the virtualization environment controller is to receive the first trace message having a first master identifier from a first application in execution in a first virtualization environment and receive a second trace message having the first master identifier from the first application in execution in a second virtualization environment, and send the first trace message having a second master identifier to the debug and test system and send the second trace message having a third master identifier to the debug and test system.

9. The apparatus of claim 8, further comprising a mapping circuit to remap the first master identifier to the second master identifier.

10. The apparatus of claim 8, wherein the virtualization environment controller is to receive the first trace message having a first channel identifier from the first application, and send the first trace message having a second channel identifier to the debug and test system.

11. The apparatus of claim 1, wherein the second platform description identifier is to identify presence of the at least one virtualization environment, and the first platform description identifier does not identify the presence of the at least one virtualization environment.

12. The apparatus of claim 1, wherein the second platform description identifier comprises a global-nested platform description identifier that is bound to a sub-range of a physical master/channel space.

13. At least one computer readable storage medium having stored thereon instructions, which if performed by a machine cause the machine to perform a method comprising:
instantiating, via a virtualization environment controller, a first virtualization environment to execute on one or more hardware circuits of a system on chip (SoC), comprising exposing a common master identifier range to the first virtualization environment, the common master identifier range to be exposed to a plurality of virtualization environments;
generating a first platform description identifier message to identify the first virtualization environment, the first platform description identifier message comprising a master identifier base value, a channel identifier base value, range information to identify a range of master identifiers and channel identifiers associated with the first virtualization environment, and type information to define a type of virtualization environment; and
sending the first platform description identifier message to a debug and test system coupled to the SoC, to enable the debug and test system to identify an incoming trace message received from the first virtualization environment.

14. The at least one computer readable storage medium of claim 13, wherein the method further comprises generating the first platform description identifier message comprising a scope field having a first value to indicate that the first platform description identifier comprises a global-nested platform description identifier.

15. The at least one computer readable storage medium of claim 13, wherein the method further comprises:
receiving, in the virtualization environment controller, a first trace message from the first virtualization environment, the first trace message comprising a first master identifier of the common master identifier range;
remapping the first master identifier of the common master identifier range to a second master identifier of the range of master identifiers; and
sending the first trace message having the second master identifier to the debug and test system.

16. The at least one computer readable storage medium of claim 13, wherein the method further comprises:
receiving, in the virtualization environment controller, a first trace message from a first application in execution in the first virtualization environment and a second trace message from the first application in execution in a second virtualization environment, the first trace message and the second trace message comprising a first master identifier of the common master identifier range;
remapping the first trace message and the second trace message to have different master identifiers; and
sending the first trace message and the second trace message having the different master identifiers to the debug and test system.

17. A system comprising:
a system on chip (SoC) comprising at least one core to execute instructions and a trace aggregator coupled to the at least one core, wherein the at least one core is to be virtualized to a plurality of virtualization environments, wherein a first virtualization environment to execute on the at least one core is to send to a virtualization controller a first trace message having a first master identifier shared with one or more other virtualization environments, wherein the virtualization controller is to remap the first master identifier to a second master identifier associated with the first virtualization environment and send the first trace message with the second master identifier to the trace aggregator; and
a debug and test system coupled to the SoC via an interconnect, the debug and test system to receive the first trace message with the second master identifier and access a first decoder subsystem using the second master identifier for use in decoding the first trace message.

18. The system of claim 17, wherein the trace aggregator is to be virtualized for use by the plurality of virtualization environments.

19. The system of claim 17, wherein the virtualization controller is to generate a platform description identifier for the first virtualization environment, the platform description identifier comprising a master identifier base value, a channel identifier base value, range information to identify a range of master identifiers and channel identifiers associated with the first virtualization environment, and type information to define a type of virtualization environment.

20. The system of claim 19, wherein the platform description identifier comprises a scope field having a first value to indicate that the platform description identifier comprises a global-nested platform description identifier that is bound to a sub-range of a physical master/channel space.
